(19) United States
(12) Patent Application Publication
(10) Pub. No.: US 2006/0150212 A1
(43) Pub. Date: Jul. 6, 2006

(54) Video-on-demand embedded advertising system and method

(75) Inventors: Ryan Randall Magnussen, Los Angeles, CA (US); Patrick Gerald Bradley, Los Angeles, CA (US)

Correspondence Address: JEFFER, MANGELS, BUTLER & MARMARO, LLP, 1900 AVENUE OF THE STARS, 7TH FLOOR, LOS ANGELES, CA, 90067, US

(73) Assignee: RIPE, LLC

(21) Appl. No.: 11/030,647

(22) Filed: Jan. 5, 2005

(51) Int. Cl. H04N 7/173

(52) U.S. Cl. 725/32; 725/132; 725/135

(57) ABSTRACT

Described is a system and method for providing advertising in a media system, including a media editor, or editing device, for embedding one or more advertisements into one or more media presentations for selective playing on one or more devices in a network. The media presentations are provided to a media distribution system for allowing selection of the one or more media presentations for playing on the one or more devices. A database is provided for recording the number of times that each advertisement is played on one of the one or more devices. A billing system is provided for charging one or more advertisers according to the recorded number of times that each advertisement is played.

### FIELD OF THE INVENTION

The invention is a video-on-demand embedded advertising system and method. More particularly, the invention provides a database for recording the number of times that a media presentation is individually shown to a subscriber of the video-on-demand system, and a billing system for charging one or more advertisers according to the recorded number of times that each advertisement is played.

### BACKGROUND

A video-on-demand (“VOD”) system combines a video display system such as a user's TV set or personal computer with information retrieval technology. This technology usually provides a specific electronic video service based on users' requests over a network. Applications of VOD include entertainment services such as movie-on-demand service, news-on-demand service, and remote learning.

In true VOD, a user is allowed to select any program from remote content archives at any time. Those archives can include audio and video materials, and multimedia titles. In addition, the user is allowed to interact at any time with the programs using operations including random access to any point in a program, fast-forward, rewind, pause/resume, slow-motion play, and other VCR-like controls.

A VOD system that does not meet all these requirements is called a near VOD system.

Near-VOD is often used in order to conserve or more efficiently use system resources. True VOD service is more desirable in order to compete with existing video rental services.

FIG. 1 shows a generic prior art VOD system 100. Multiple users 120 are served by networked servers 102 and 107 over a network 103. The solid lines represent the data flow for video and other data. The dashed lines represent the communication signal flow for controls and requests. Arrows indicate the flow direction.

The information sources of the system 100 are the networked remote server 102 connected to a backbone network 104 and the local server 107 in an access node 106. Servers 102 and 107 can include one or multiple servers that have massive storage devices and media controllers for storing a large number of databases including videos, multimedia titles, interactive games and others. Servers 102 and 107 are capable of serving a considerable number of simultaneous user requests to the same or to different programs on demand.

One or more electronic controllers 130 are deployed in the network 103 to control and monitor the operations of the VOD system 100. A controller may be a computer that controls the networked servers to operate under an operation protocol. The basic functions supported by the controller include request handling, support of user interactions, admission control and quality-of-service guarantees.

Storage media for servers 102 and 107 usually include magnetic disks, optical disks, and magnetic tapes. Such media are usually organized hierarchically to increase cost-effectiveness. For example, the more popular programs are stored on random access media, such as magnetic disks, for fast access and expedited distribution. The less-popular programs are stored in devices with longer access latencies such as a tape drive, and retrieved as necessary to a disk drive for processing.

The backbone network 104 may include high-speed switches and transport protocols which connect remote servers at geographically dispersed locations. One trend is towards a synchronous optical network (“SONET”) backbone with asynchronous transfer mode (“ATM”) switching because of their low error rate, high data transfer rate, capability of bandwidth-on-demand, and seamless services.

An access node 106 serves as a bridge between the backbone network 104 and access network 110. A plurality of such access nodes are deployed to link multiple access networks to the backbone network. Depending on the system implementation, the access node 106 may be a head-end in CATV networks, a central office in a telephone network, or a base station in mobile systems. The access node 106 may be equipped with satellite dishes to receive analog broadcast TV programs. Examples of access networks include a hybrid fiber coax (“HFC”) system, asymmetric digital subscriber loop (“ADSL”) system, fiber to the curb (“FTTC”) system, wireless cable system, and direct broadcast satellite (“DBS”) system.

A subscriber terminal unit or “set-top box” 120 in FIG. 1 forms an interface between the user and the VOD network. It receives, demodulates, and decodes the information. The user can interact with the VOD system by sending out control commands and service requests, typically through a remote control. The set-top box has interfaces to video/audio output devices (e.g., a computer, a TV or a telephone) and can be integrated as a part of the video/audio output device. A user can be connected to servers 102 and 107 with various user interfaces such as on-screen images and cursor-like devices.

Various VOD systems are reviewed by T. S. Perry in “The Trials and Travails of Interactive TV,” IEEE Spectrum, pp. 22-28, April, 1996.

### SUMMARY OF THE INVENTION

Briefly, and in general terms, the invention provides a system and method for providing advertising in a media. One or more advertisements are embedded into one or more one or more media presentations for selective playing on one or more devices in a network. The system allows selection of the one or more media presentations for playing on the one or more devices. The number of times that each advertisement is played is on one of the one or more devices is recorded. As a result of such recording, one or more advertisers are charged according to the recorded number of times that each advertisement is played.

In accordance with an aspect of a preferred embodiment, at least one of the advertisements comprises a splash lead-in graphic.

In accordance with an aspect of another preferred embodiment, at least one of the advertisements comprises an animated logo.

In accordance with an aspect of another preferred embodiment, at least one of the advertisements comprises a ghosted logo.

In accordance with an aspect of another preferred embodiment, at least one of the advertisements comprises a graphic frame.

In accordance with an aspect of another preferred embodiment, at least one of the advertisements comprises a video banner.

In accordance with an aspect of another preferred embodiment, at least one of the advertisements comprises a splash out graphic.

In accordance with an aspect of another preferred embodiment, at least one of the advertisements comprises a commercial spot. For example, the commercial spot may be a typical long-form-type advertising commercial spot as seen on television.

### BRIEF DESCRIPTION OF THE DRAWINGS

FIG. 1 shows a generic prior art video-on-demand (VOD) system;

FIG. 2 is a diagram that illustrates components of a VOD system on which a preferred embodiment of the present invention operates;

FIG. 3 is a database entity diagram that illustrates an exemplary subscriber activity recording database that may store the activity information received from the billing system in a storage device of FIG. 2;

FIG. 4 is a flow diagram that illustrates a sample sequence of a splash lead-in graphic type advertisement according to one embodiment;

FIG. 5 is a flow diagram of a continuation of the sequence of the splash lead-in graphic example of FIG. 4;

FIG. 6 is a diagram that illustrates a sample of a glass logo bug type advertisement according to one embodiment;

FIG. 7 is a diagram that illustrates a sample jumping logo bug graphic advertisement “jumping” across a media presentation on a screen according to one embodiment;

FIG. 8 is a flow diagram illustrating a sample sequence of a “video bark short forum” type advertisement according to one embodiment;

FIG. 9 is a flow diagram that illustrates a sample sequence of a “video bark long forum” type advertisement according to one embodiment;

FIG. 10 is a diagram illustrating a sample television skin advertisement on a screen according to one embodiment; and

FIG. 11 is a flow diagram illustrating a sample sequence of a “splash lead-out” type advertisement according to one embodiment.

### DETAILED DESCRIPTION

An embodiment of a system and method for providing advertising in a media system, constructed in accordance with the claimed invention, provides a media editor, or editing device, for embedding one or more advertisements into one or more media presentations for selective playing on one or more devices in a network. The media presentations are provided to a media distribution system for allowing selection of the one or more media presentations for playing on the one or more devices. A database is provided for recording the number of times that each advertisement is played on one of the one or more devices. A billing system is provided for charging one or more advertisers according to the recorded number of times that each advertisement is played.

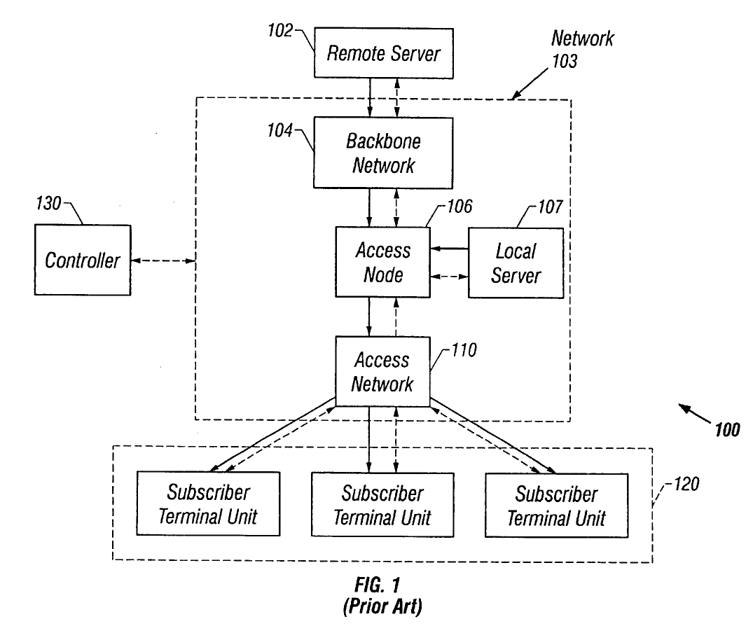

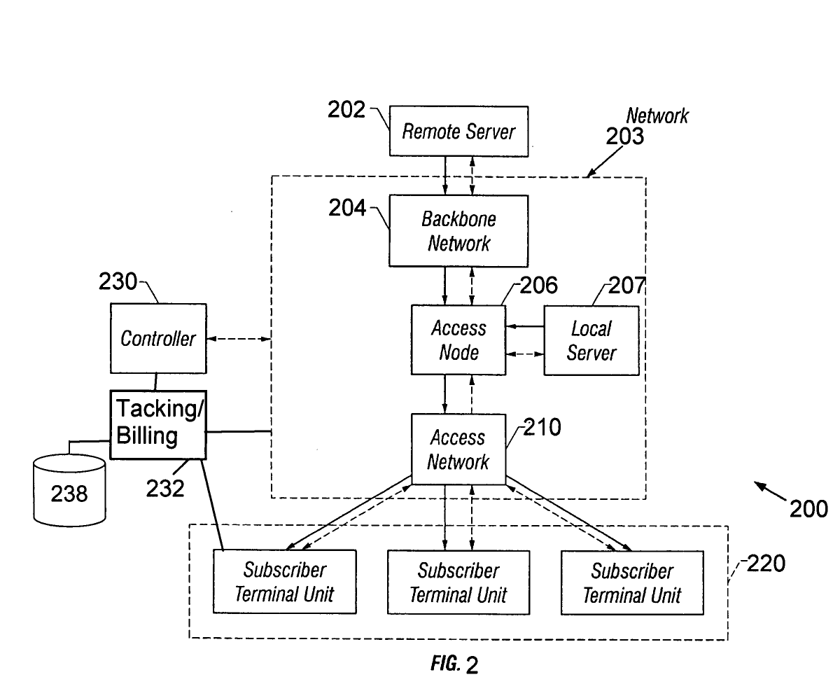

With reference to FIG. 2, a diagram illustrates components of a video-on-demand (VOD) system 200 on which a preferred embodiment of the present invention operates. As stated above with respect to the prior art generic VOD system 100 of FIG. 1, the system 200 of FIG. 2 serves multiple users 220 by networked servers 202 and 207 over a network 203.

Networked remote server 202 is connected to a backbone network 204 and the local server 207 in an access node 206. Servers 202 and 207 preferably have massive storage devices and media controllers for storing a large number of databases including videos, multimedia titles, interactive games and others, and are capable of serving a considerable number of simultaneous user requests to the same or to different programs on demand.

One or more electronic controllers 230 are deployed in the network 203 to control and monitor the operations of the VOD system 200. A controller may be a computer that controls the networked servers to operate under an operation protocol. The basic functions supported by the controller include request handling, support of user interactions, admission control and quality-of-service guarantees.

Servers 202 and 207 include storage media such as magnetic disks, optical disks, and magnetic tapes, organized hierarchically to increase cost-effectiveness. More popular programs are stored on random access media, such as magnetic disks, for fast access and expedited distribution. The less-popular programs are stored in devices with longer access latencies such as a tape drive, and retrieved as necessary to a disk drive for processing.

The backbone network 204 may include high-speed switches and transport protocols which connect remote servers at geographically dispersed locations. The backbone may comprise a synchronous optical network (“SONET”) backbone with asynchronous transfer mode (“ATM”) switching.

As in prior art systems, an access node 206 serves as a bridge between the backbone network 204 and access network 210. A plurality of such access nodes are deployed to link multiple access networks to the backbone network. Depending on the system implementation, the access node 206 may be a head-end in CATV networks, a central office in a telephone network, or a base station in mobile systems. The access node 206 may be equipped with satellite dishes to receive analog broadcast TV programs. Examples of access networks include a hybrid fiber coax (“HFC”) system, asymmetric digital subscriber loop (“ADSL”) system, fiber to the curb (“FTTC”) system, wireless cable system, and direct broadcast satellite (“DBS”) system.

A typical prior art subscriber terminal unit or “set-top box” 220 may provide the interface between the user and the VOD network, without modification.

As part of, or connected to the controller 230 is a network tracking and billing system 232. The tracking and billing system 232 monitors activities performed on set top terminals 220. Polling of the set top terminals occurs frequently enough to allow the billing system 232 to maintain accurate account and billing information for media or video presentations ordered, as well as monitor authorized channel access.

In one embodiment, information to be sent to the billing system 232 is stored in a random access memory (RAM) within each subscriber's set top terminal 220, and will be retrieved only upon polling by the billing system 232 to monitor billable subscriber activities, such as an order of a movie for viewing. Retrieval may, for example, occur on a daily, weekly or monthly basis. However, it may be preferable to poll activities more frequently, such as every half hour or 10 minutes, just in case a set top terminal 220 fails or is turned off for a period of time.

In one embodiment, the polling of the set top terminals by the billing system may occur through the network 200. However, in some systems, there may be separate and direct connections to the set top terminals, such through digital subscriber lines (DSL) over telephone lines, or through Internet connections.

In another embodiment, the controller polls signals sent across the network 200 to determine subscriber activities, without the need to poll the set top terminals 220 directly. After the activity information is collected, it is stored in a database on a storage device 238, which may comprise hard disk storage, optical storage, or the like. The storage device may be physically local with respect to the controller 230 and billing system 232, or it may be located on-line at an off-site location that may, for example be operated by a third party cable and media billing service, such as Amdocs located in Israel.

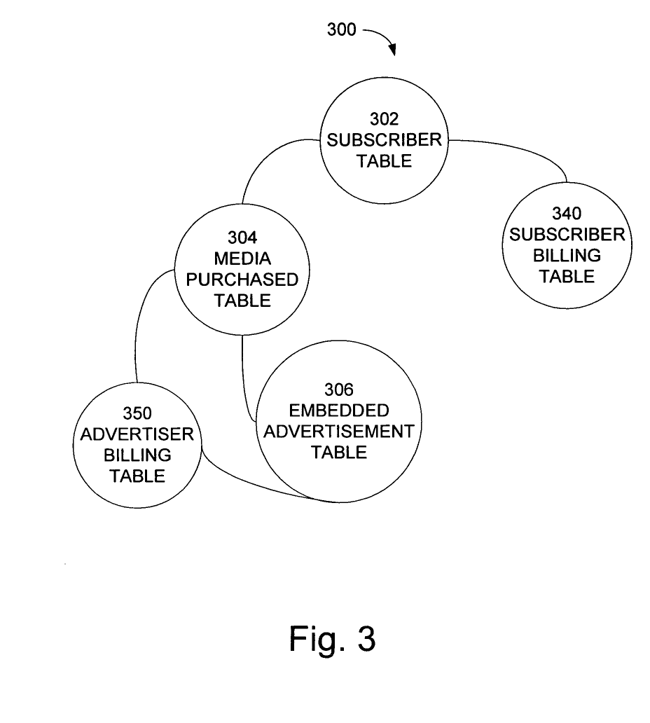

With reference to FIG. 3, a database entity diagram illustrates a subscriber activity recording database 300 that may store the activity information received from the billing system 232 in storage device 238. The database 300 may comprise a relational or object oriented database having several tables. For example, at the head of the database may be a master subscriber table 302 that contains information on each of the subscribers in the network 200. This table stores such information as set top box identifiers, number of set top boxes at the home or location, premium channels currently subscribed to, and other subscriber related information.

The subscriber table 302 is linked to the subscriber billing table 340, which stores information necessary to provide the subscriber with monthly bills according to regular monthly services subscribed to by the subscriber, as well as one-time charges such as video-on-demand purchases. In this regard, the subscriber table 302 is also linked to a media purchased table 304, which keeps track, for each subscriber in each month, information regarding the one-time charges for the subscriber. The media purchased table 304 may be keyed, for example, by a media ID, which relates to each type of one-time charge. For example, for each subscriber, there may be zero, or several records stored in the media purchased table 304, depending on the media services each subscriber has viewed or purchased during the particular month. The media ID for each purchase or viewing appears in the table for each subscriber, so that the system may determine exactly which media item was purchased by each subscriber.

It should be noted herein that the term “purchased media” does not, and is not meant to imply, that a subscriber has paid for the media presented. In other words, the purchase price may by zero. For example, some video-on-demand presentations may be completely advertiser supported in the system described herein.

In this regard, regardless of whether a subscriber does, or does not, pay for a media presentation, the system 200, using the database 300, keeps track of 1) each time a subscriber orders a particular media presentation, and 2) each embedded advertisement that was presented during the media presentation. This is accomplished by using an embedded advertising table 306, which keeps track of what advertisements are embedded in which media presentations. One or more advertisement IDs are matched to each media presentation ID in the embedded advertising table 306. Thus, by querying the media purchased table 304, and the embedded advertising table 306, for example by a union operation, the system may determine the number of times each embedded advertisement was included in a media presentation provided to a subscriber. Thus, an advertiser billing table 350 may be set up that is linked to both the media purchased table 304 and the embedded advertising table 306 that represents the union of tables 304 and 306.

From the advertiser billing table 350, each owner of each embedded advertisement may be billed based on the number of times one or more of their advertisements were presented to a subscriber. For example, from the advertiser billing table 350, each advertiser may be billed each month based on the precise number of times that one of their advertisements was viewed by a subscriber.

Any one or more of a number of advertising formats may be embedded into a media presentation. Each of these advertisement formats may be embedded and mixed into one or more of the media presentations available in the system 200 by known software techniques and systems. For example, Mental Ray®, or Renderman®, may be used for TIF output of a still image sequence. The still image sequence is rendered out as TIF files on a network render farm, to include an alpha channel, for both television (720×480) and broadband (640×480) formats. The image sequence is imported for video editing on a Macintosh® non-linear editing system in either Avid® or Final Cut Pro®. The TIF Video sequence is imported into the media presentation in which the advertisement is to be embedded, and “baked” in together with an accompanying voice over, if any, and or other sound effects, if any, to further enhance the overall viewing experience.

A list of software that can be used to perform the integration of the embedded advertisements and media presentations includes, but is not limited to: Discreet 3DS Max® (Animation and Rendering), Avid Softimage Xsi® (Polygon Modeling), Alias Wavefront®—Maya® (NURBS Modeling), Adobe Photoshop®, Adobe Illustrator®, Digimation Plugins® for 3DS Max®, Discreet Combustion®, Adobe After Effects®, Adobe Premiere Pro®, Sony Sound Forge®, Mental Ray Renderer®, Pixar Renderman®, Cebas Final Render Stage®, Discreet Plasma®, Macromedia Flash®, Avid Express®, Final Cut Pro®, Corbis.com Stock Photography®.

One advertising format comprises a splash lead-in graphic. This advertising spot typically lasts 11 to 15 seconds, and comprises a sponsor's logo or related brand graphic used as part of short 3D intro animation, integrated with the media presentation, in an effort to capture the viewer's attention in a creative and entertaining way, while making the viewer brand aware, while still maintaining the highest level of quality for original programming. Shown, for example, is the BMW® automobile symbol as part of the splash lead-in advertising spot.

During the media presentation, the graphic animated background and foreground fades in from black. The brand or logo builds or flies into the screen on a alpha channel background. A brand “tag line” or slogan appears as part of animation build up (i.e. BMW®—“The Ultimate Driving Machine”®). Voice over or animated text presents the media presentation (i.e. “Presented by BMW®”). An alpha channel “graphic hole” appears in the media presentation, making the media presentation visible in background, which is enlarging to full screen. The original media presentation then appears full screen.

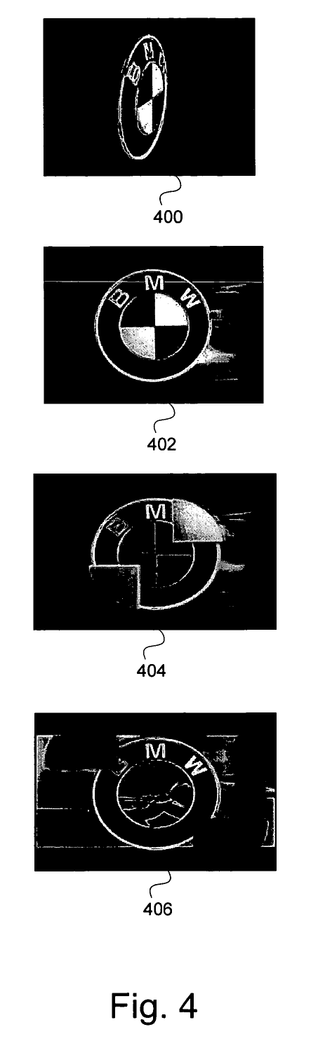

With reference to FIG. 4, a flow diagram illustrates a sample sequence of a splash lead-in graphic animation using the BMW® logo according to one embodiment. In step 400 of the sequence, the BMW® Logo fades in from black and starts rotating clockwise, with black and white BMW® video footage in the background. In step 402, the logo completes a 90 deg turn to face the viewer. There is black and white video playing in background of a hand changing gears, and audio overlay of a car engine. In step 404, the BMW® logo quadrants start breaking up. First, 2 white corners zoom out towards the viewer, leaving the alpha channel visible in background. There is still black and white video playing in background of a hand changing gears, and audio overlay of car engine. In step 406, the BMW® logo quadrants continue to break up. Blue corners zoom out towards the viewer, leaving the alpha channel visible in the background. Live video fades into the alpha channel. Black and white video is playing in background of a BMW® car pulling away. The original audio from the media presentation fades in with video of the media presentation.

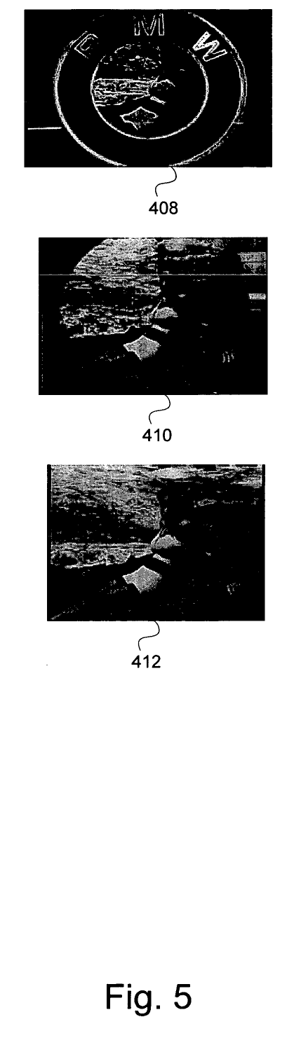

With reference to FIG. 5, the sequence of the splash lead-in graphic example of FIG. 4 continues. In step 408, the logo with the alpha channel circle zooms towards the viewer, displaying the original media presentation video content inside the circle. Black and white video continues playing in background of a BMW® car pulling away. The original audio from the media presentation introduces the video inside the circle. In step 410, the BMW® logo within the alpha channel circle continues to zoom towards the viewer, displaying the original media presentation video content inside the circle. Black and white video continues playing in background of a BMW® car pulling away. Original audio from the media presentation is now playing. In step 412, the logo having now disappeared, the full screen of the media presentation begins.

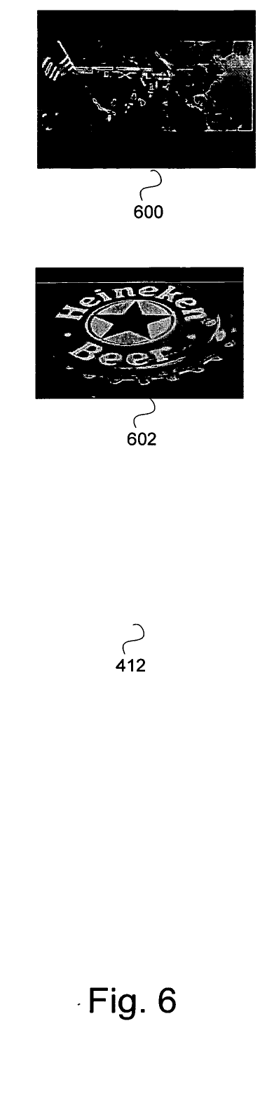

With reference to FIG. 6, a diagram illustrates a sample of a glass logo bug type advertisement according to one embodiment. The glass logo bug comprises a static semi-translucent grayscale Heineken® logo in an alpha channel that is displayed in the bottom right corner of the screen over the media presentation. At 600, the Heineken® glass logo bug fades in at bottom right corner of screen. At 602, an enlarged version of same logo from the bottom right of screen 600 is shown. As can been seen in FIG. 6, the glass logo bug serves as a non-intrusive constant reminder to the viewer of the particular advertiser. It also boosts a subconscious message to the viewer of the sponsor of the show.

Preferably, in order to construct the glass log bug into a video, an original high quality bitmap of the logo is received from the sponsor. Alternatively, it could be in a vector format file for Adobe Illustrator®. A preview of the logo may be created on a plain black background in several different angles. For the best results, it is preferred that the logo is built in 3D, and metallic texture maps are applied to the various aspects of the logo. This creates a shine highlight effect, simulating glass. A lighting effect may then be applied on the logo by rendering the final logo using Mental Ray®. The logo may be touched up and modified using Photoshop® software. The final media presentation with the log is rendered and cropped on a Machintos® editing system for all platforms necessary, such as television, broadband and mobile streaming.

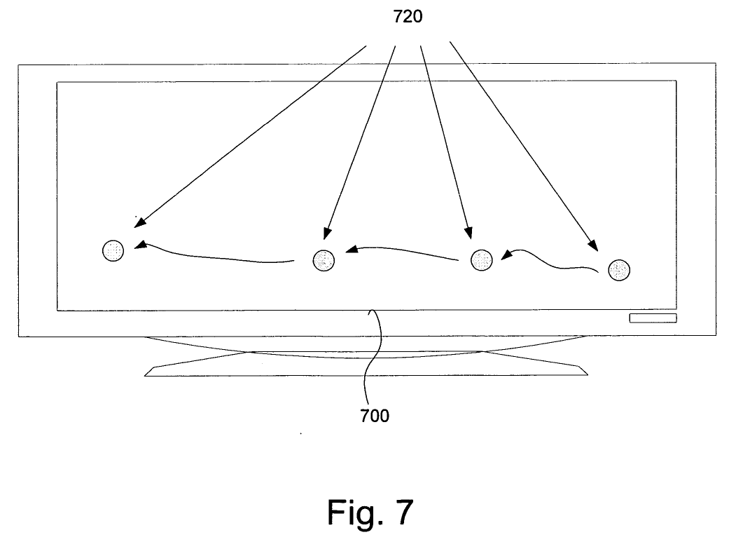

With reference to FIG. 7, a diagram illustrates a sample jumping logo bug graphic 720 “jumping” across a media presentation on a screen 700 according to one embodiment. The jumping logo bug 720 is an animated branded graphic or logo that moves or flies across the lower 3rd of the screen 700, either left or right, to draw the viewer's attention and make them brand aware.

Design specifications and animation concepts for the jumping logo bug 720 may be drafted using a traditional storyboard outline. Next, the following resources may be gathered:

a. high quality photos (original or stock)

b. logos in vector format

c. additional brand imagery

d. 3D models

e. video from the sponsor

f. any existing advertisements to help with branding of animation

Where 3D models are not available, two dimensional graphics may be edited and finalized in two dimensional paint packages such as Photoshop®. In another case, a rough animated preview of the animation may be created to determine correct overall speed and on-screen pauses for brand recognition. A final mesh may then be applied, as well as final mesh modifiers and subdivision surfaces for optimal object appearance in the final render of the animation. Various final textures and materials may further be applied to objects in the animation.

A video post-in may be set up in 3Ds Max® with additional effects such as glow, lens flare, and the like. A final software renderer (i.e. Mental Ray, or Renderman) may be used for TIF output. A still image sequence is rendered out as TIF files in a network render farm, to include alpha channel, for both television (720×480) and broadband (640×480). The image sequence is imported for video editing on a Macintosh non-linear editing system in either Avid® or Final Cut Pro®. The TIF Video sequence is imported into the original media presentation, and “baked” in.

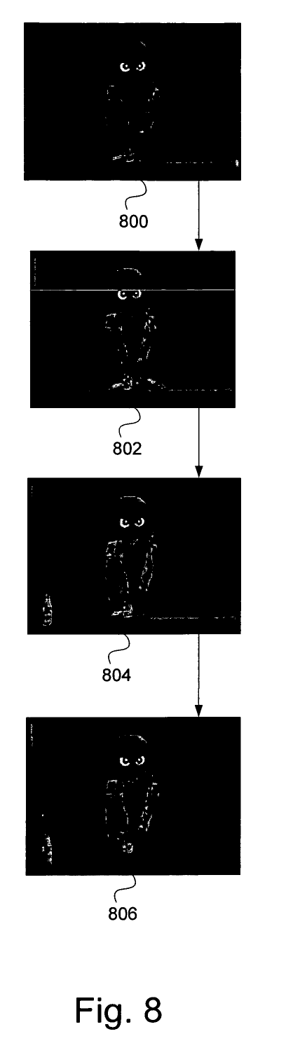

With reference to FIG. 8, a flow diagram illustrates a sample sequence of a “video bark short forum” type advertisement according to one embodiment. Using a video bark short form, a sponsor's logo, or related brand graphics, are used as part of a 3D animation or motion effect occurring in the lower third of a media presentation screen, in an effort to capture the viewer's attention, making them brand aware. In the example of FIG. 8, an advertisement for Heineken® brand beer is shown. In step 800, the beer bottle appears on the bottom right side of the screen, and starts animating towards left side. At step 802, the bottle continues to animate towards the left side while rolling across the bottom of the screen. At step 804, the bottle falls into place with the logo on the bottle clearly visible. At step 806, the green panel slides in from below, behind the bottle to create an area for messaging.

The techniques for providing this animation in the media presentation are same as that explained above, for example with respect to FIGS. 4-5.

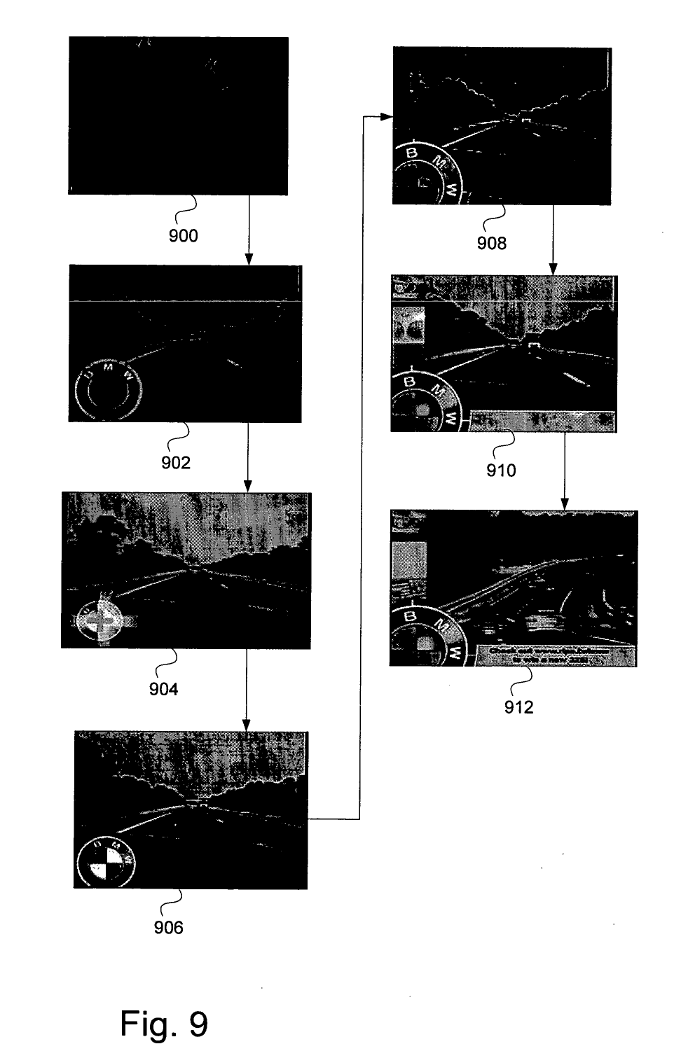

With reference to FIG. 9, a flow diagram illustrates a sample sequence of a “video bark long forum” type advertisement according to one embodiment. Using a video bark long form, a sponsor's logo, or related brand graphics, are used as part of a 3D animation or motion effect occurring in lower third of screen, in an effort to capture the viewer's attention, making them brand aware. Although the style of animation may differ from brand to brand depending on object shapes and logo design the basic functionality will be executed as follows:
a) An animated logo flies in and takes position in lower left corner on an alpha channel background.
b) Bottom and left side brand panels build up or slide out into position to become part of logo on the alpha channel background.
c) The left side panel displays animated branded imagery from the sponsor while the bottom panel will show the name of a person being interviewed in the media presentation, or direct the user to a website address for a survey to provide competition results for use by the sponsor.
d) Additional sounds effects may increase the overall effect of the animation building up.
e) After 30 seconds of display, the branded graphic panels will either fold away with animation or dissolve away to the background video while the logo in the bottom left side of the screen flies off the screen.

The example in FIG. 9 illustrates the use of the video bark long forum type of advertisement using the BMW® logo. In step 900, the BMW® logo zooms out over the media presentation, or from a black background, towards the lower left corner of the screen. In step 902, the logo completes a zoom-out to the bottom left corner with an alpha channel hole in the middle of the logo. In step 904, a volumetric lighting effect fills the logo quadrants, and the outside part of the logo's ring immediately starts rotating clockwise. In step 906, the logo's ring with letters continues to rotate clockwise while zooming slightly towards the viewer to enlarge the logo. In step 908, the logo comes to a final position while the top and bottom graphic panels fold in towards the media presentation. White Quadrants of the logo fall away to reveal additional background video.

In step 910, graphic panels continue to fold in over the media presentation with branded imagery of an automobile related to the logo on the left side panel in a slide show format. A fast moving lens flares to accentuate the panel edges. In step 912, the graphic panels and logo dissolve away to the video in the background.

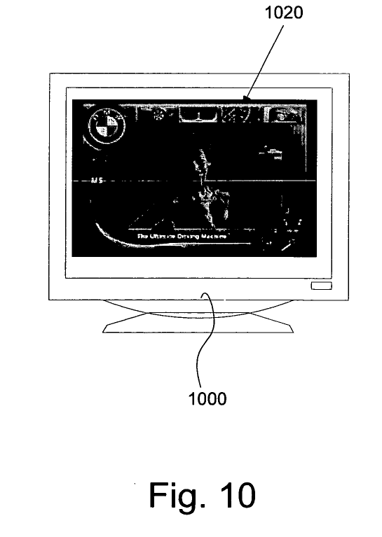

With reference to FIG. 10, a diagram illustrates a sample television skin 1020 on a screen 1000 according to one embodiment. The television skin is a static custom designed graphic frame that fits the outside borders of a media presentation, and encapsulates the media presentation with rich sponsor branded design elements, but while staying with design restrictions of the brand itself. The television skin 1020 fades in and out over the media presentation on the screen 1000.

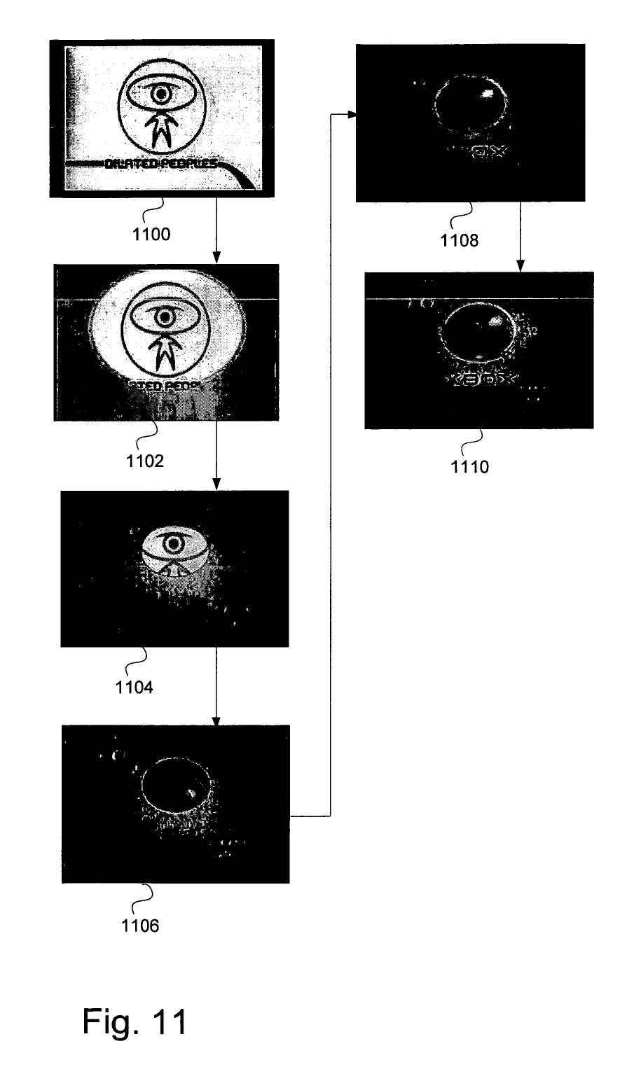

With reference to FIG. 11, a flow diagram illustrates a sample sequence of a “splash lead-out” type advertisement according to one embodiment. At step 1100, the media presentation comes to an end. A motion graphic containing a logo (in this illustration, an XBOX® logo) within an alpha channel hole zooms out towards the center of screen, step 1102. The media presentation is still visible in the background as shown. The advertising motion graphic animates (in this chase showing 0s and 1s revolving around the XBOX® logo folding in towards the viewer from behind the alpha channel), step 1104. The media presentation has now faded to black in the background, and silver rings zoom out toward the logo.

The advertisement motion graphic continues to animate (e.g., the 0s and 1s continue to revolve around the XBOX® logo) folded into the alpha channel hole, step 1106. The silver rings zoom out to outline the spherical logo, which starts to pulsate in a green glow. In step 1108, the advertising motion graphic continues to animate, while the silver rings provide a lens flare animating around edge of the rings, step 1108. The letters of the logo (e.g. X-B-O-X) zoom out in a blurred motion to appear on-screen below the logo. In step 1110, all of the letters have appeared in clear view. Finally, in step 1112, the advertisement screen fades to black.

It will be apparent from the foregoing that, while particular forms of the invention have been illustrated and described, various modifications can be made without departing from the spirit and scope of the invention. Accordingly, it is not intended that the invention be limited, except as by the appended claims.

What is claimed is:

1. A method for providing advertising in a media system, comprising:
embedding one or more advertisements into one or more media presentations for selective playing on one or more devices in a network;
allowing selection of the one or more media presentations for playing on the one or more devices;
recording the number of times that each advertisement is played on one of the one or more devices;
charging one or more advertisers according to the recorded number of times that each advertisement is played.

2. The method of claim 1 wherein at least one of the advertisements comprises a splash lead-in graphic.

3. The method of claim 1 wherein at least one of the advertisements comprises an animated logo.

4. The method of claim 1 wherein at least one of the advertisements comprises a ghosted logo.

5. The method of claim 1 wherein at least one of the advertisements comprises a graphic frame.

6. The method of claim 1 wherein at least one of the advertisements comprises a video banner.

7. The method of claim 1 wherein at least one of the advertisements comprises a splash out graphic.

8. The method of claim 1 wherein at least one of the advertisements comprises a commercial spot.

9. The method of claim 8 wherein the commercial spot is long-form.

10. A system for providing advertising in a media system, comprising:
a media editor for embedding one or more advertisements into one or more media presentations for selective playing on one or more devices in a network;
a media distribution system for allowing selection of the one or more media presentations for playing on the one or more devices;
a database for recording the number of times that each advertisement is played on the one or more devices;
a billing system for charging one or more advertisers according to the recorded number of times that each advertisement is played.

11. The system of claim 10 wherein at least one of the advertisements comprises a splash lead-in graphic.

12. The system of claim 10 wherein at least one of the advertisements comprises an animated logo.

13. The system of claim 10 wherein at least one of the advertisements comprises a ghosted logo.

14. The system of claim 10 wherein at least one of the advertisements comprises a graphic frame.

15. The system of claim 10 wherein at least one of the advertisements comprises a video banner.

16. The system of claim 10 wherein at least one of the advertisements comprises a splash out graphic.

17. The method of claim 10 wherein at least one of the advertisements comprises a commercial spot.

18. The method of claim 17 wherein the commercial spot is long-form.
